(19) United States
(12) Patent Application Publication
(10) Pub. No.: US 2019/0337334 A1
(43) Pub. Date: Nov. 7, 2019

(54) Caster Assembly with Low Friction Caster Wheel

(71) Applicant: Stryker Corporation, Kalamazoo, MI (US)

(72) Inventor: Kevin Mark Patmore, Portage, MI (US)

(21) Appl. No.: 16/400,450

(22) Filed: May 1, 2019

Related U.S. Application Data
(60) Provisional application No. 62/665,956, filed on May 2, 2018.

(51) Int. Cl. B60B 35/00; B60B 33/00; A61G 7/10

(52) U.S. Cl. CPC B60B 35/009; B60B 33/0055; B60B 2200/242; A61G 7/1046; B60B 2900/1212; B60B 33/0036

(57) ABSTRACT

A patient transport apparatus comprises a support structure comprising a base and a patient support surface for supporting a patient and a caster assembly coupled to the base. The caster assembly comprises a wheel assembly. The wheel assembly includes a first edge, a second edge, and a center disposed between the first edge and the second edge. Each of the edges have a lower coefficient of friction than the center. The caster assembly further includes a tilt assembly coupled to the wheel assembly. The tilt assembly is configured to allow the wheel assembly to tilt relative to a floor surface such that at least one of the first and second edges contact the floor surface.

### RELATED APPLICATION

This application claims the benefit of and priority to U.S. Provisional Patent Application No. 62/665,956, filed on May 2, 2018, the entirety of which is hereby incorporated herein by reference.

### BACKGROUND

Patient transport apparatuses, such as hospital beds, stretchers, cots, wheelchairs, and chairs facilitate care of patients in a health care setting. Conventional patient transport apparatuses comprise a support structure having a base, a frame, and a patient support deck upon which the patient is supported. The patient transport apparatus may further comprise caster assemblies including caster wheels to facilitate transport of the patient transport apparatus over floor surfaces.

Caster assemblies provide caster wheels with low rolling resistance, which is beneficial for smooth and rapid transport of a patient transport apparatus. Caster wheels are usually self-aligning, such that they transition from their current orientation to a trailing orientation when the direction of the patient transport apparatus is changed. Sometimes during this transition, such as when the caster wheel needs to reorient 180 degrees from a leading orientation to a trailing orientation, the caster wheel ceases to roll, normally in a stall zone spanning an angular region transverse to the desired direction of travel. This is known as a “stalled” state. During a stalled state, pivoting of the caster wheel occurs at a junction between the caster wheel and the floor surface. Due to the coefficient of friction between the caster wheel and the floor, and high normal forces, the frictional forces that resist such pivoting are high. These frictional forces are one of the main reasons that caregivers can find it difficult to change directions when moving a patient transport apparatus with self-aligning caster wheels, i.e., high start-up pushing forces may need to be applied by the caregiver to overcome the frictional forces that resist the pivoting of one or more of the caster wheels through the stall zone. Thus, a caregiver may experience difficulty in changing the direction of travel of the patient transport apparatus, slowing or even stopping the transport temporarily.

A caster assembly is desired that addresses one or more of the aforementioned challenges.

### BRIEF DESCRIPTION OF THE DRAWINGS

FIG. 1 is a perspective view of a patient transport apparatus.

FIG. 2 is a side view of a caster assembly according to a first embodiment.

FIG. 2A is an illustration of a stall zone of the caster assembly of FIG. 2.

FIG. 3 is a front view of the caster assembly of FIG. 2 in a first position.

FIG. 4 is a front view of the caster assembly of FIG. 2 in a second position.

FIG. 5 is a front view of the caster assembly of FIG. 2 in a third position.

FIG. 6 is a side view of a caster assembly according to a second embodiment.

FIG. 7 is a front view of the caster assembly of FIG. 6 in a first position.

FIG. 8 is a front view of the caster assembly of FIG. 6 in a second position.

FIG. 9 is a front view of the caster assembly of FIG. 6 in a third position.

FIG. 10 is a front view of a caster assembly according to a third embodiment.

FIG. 11 is a front view of a caster assembly according to a fourth embodiment.

FIG. 12 is a front view of a caster assembly according to a fifth embodiment.

### DETAILED DESCRIPTION

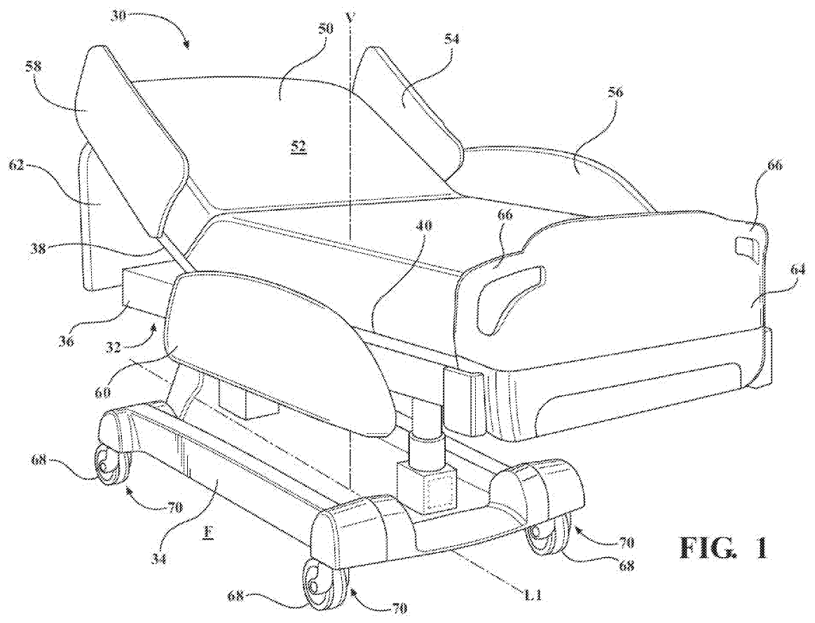

Referring to FIG. 1, a patient transport apparatus 30 is shown for supporting a patient in a health care setting. The patient transport apparatus 30 illustrated in FIG. 1 comprises a hospital bed. In other embodiments, however, the patient transport apparatus 30 may comprise a stretcher, cot, wheelchair, chair, or similar apparatus utilized in the care of a patient.

A support structure 32 provides support for the patient. The support structure 32 illustrated in FIG. 1 comprises a base 34 and a support frame 36 disposed above the base 34 and supported by the base 34. The support structure 32 also comprises a patient support deck 38 disposed on the support frame 36. The patient support deck 38 comprises sections, some of which are capable of articulating (e.g., pivoting) relative to the support frame 36. The patient support deck 38 provides a patient support surface 40, upon which the patient is supported.

A mattress 50 is disposed on the patient support deck 38 during use. The mattress 50 comprises a secondary patient support surface 52 upon which the patient is supported. The base 34, support frame 36, patient support deck 38, and patient support surfaces 40, 52, each have an upper section comprising a head end and a lower section comprising a foot end corresponding to designated placement of the patient's head and feet on the patient transport apparatus 30. The base 34 comprises a longitudinal axis L1 along its length from the head end to the foot end. The base 34 also comprises a vertical axis V arranged crosswise (e.g., perpendicularly) to the longitudinal axis L1 along which the support frame 36 is lifted and lowered relative to the base 34. The construction of the support structure 32 may take on any known or conventional design, and is not limited to that specifically set forth above. In addition, the mattress may be omitted in certain embodiments, such that the patient rests directly on the patient support surface 40.

Patient barriers, such as side rails 54, 56, 58, 60 are coupled to the support frame 36 and/or patient support deck 38 and are thereby supported by the base 34. If the patient transport apparatus 30 is a stretcher or a cot, there may be fewer side rails.

A headboard 62 and a footboard 64 are coupled to the support frame 36. The headboard 62 and footboard 64 may be coupled to any location on the patient transport apparatus 30, such as the support frame 36 or the base 34.

Caregiver interfaces 66, such as handles, are shown integrated into the footboard 64 to facilitate movement of the patient transport apparatus 30 over a floor surface F. Additional caregiver interfaces 66 may be integrated into other components of the patient transport apparatus 30, such as the headboard 62 or the side rails 54, 56, 58, 60. The caregiver interfaces 66 are graspable by the caregiver to manipulate the patient transport apparatus 30 for movement, and the like. Other forms of the caregiver interface 66 are also contemplated. The caregiver interface 66 may comprise one or more handles coupled to the support frame 36. The caregiver interface 66 may simply be a surface on the patient transport apparatus 30 upon which the caregiver logically applies force to cause movement of the patient transport apparatus 30 in one or more directions, also referred to as a push location. This may comprise one or more surfaces on the support frame 36 or base 34. This could also comprise one or more surfaces on or adjacent to the headboard 62, footboard 64, and/or side rails 54, 56, 58, 60. In other embodiments, the caregiver interface 66 may comprise separate handles for each hand of the caregiver. For example, the caregiver interface may comprise two handles.

Wheels 68 are coupled to the base 34 to facilitate transport over the floor surface F. The wheels 68 are arranged in each of four quadrants of the base 34 adjacent to corners of the base 34. In the embodiment shown, the wheels 68 are caster wheels able to rotate and swivel relative to the support structure 32 during transport. Each of the wheels 68 forms part of a caster assembly 70. Each caster assembly 70 is mounted to the base 34. Various configurations of the caster assemblies 70 are described in more detail below. Additional wheels are also contemplated. For example, the patient transport apparatus 30 may comprise four non-powered caster wheels 68, along with one or more powered wheels.

In other embodiments, one or more auxiliary wheels (powered or non-powered), which are movable between stowed positions and deployed positions, may be coupled to the support structure 32. In some cases, when these auxiliary wheels are located between caster assemblies 70 and contact the floor surface F in the deployed position, they cause two of the caster assemblies 70 to be lifted off the floor surface F thereby shortening a wheel base of the patient transport apparatus 30. A fifth wheel may also be arranged substantially in a center of the base 34.

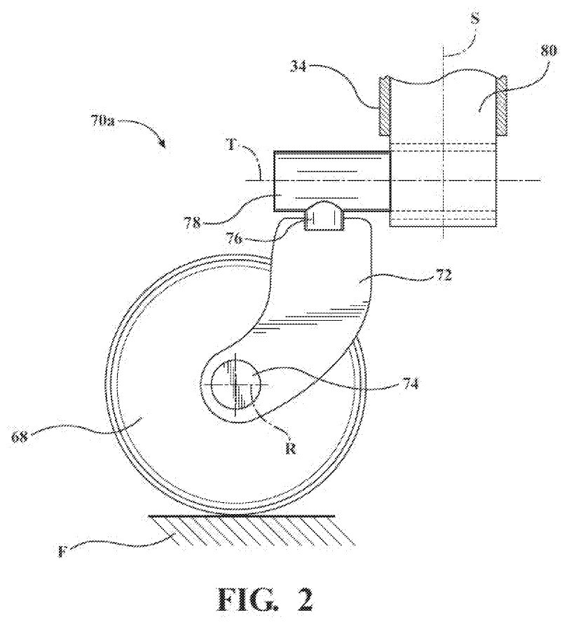

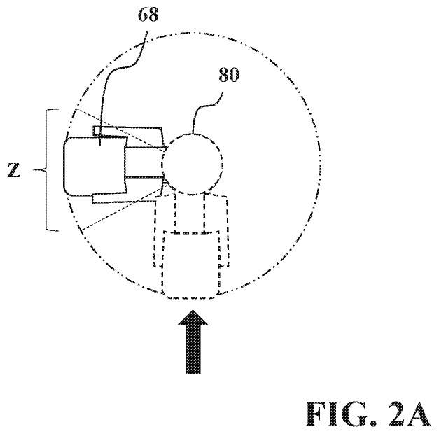

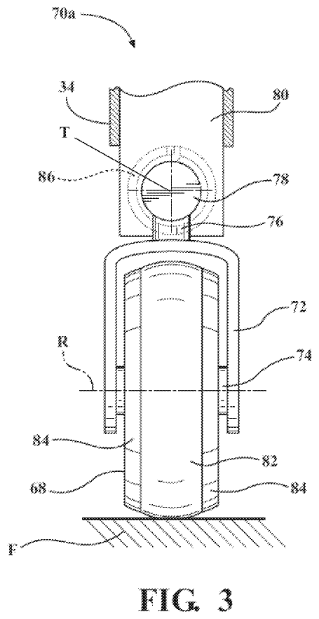

Referring now to FIGS. 2 and 3, a caster assembly 70a according to a first embodiment is shown. The caster assembly 70a comprises the wheel 68, a wheel support, and a caster stem 80. The wheel support is arranged to support the wheel 68 for rotation when rolling along the floor surface F. The wheel support may comprise various types of support structures. The wheel support shown in FIG. 2 comprises a caster horn having a fork member 72 and a post 76 fixed to the fork member 72. The wheel 68 is secured to the fork member 72 via an axle 74. The wheel 68 is arranged to rotate about a rotational axis R defined through the axle 74. The wheel 68 may rotate relative to the axle 74 via a wheel bearing (not shown) or the wheel 68 may be fixed to the axle 74 to rotate with the axle 74 relative to the fork member 72. Other configurations that allow the wheel 68 to rotate about the rotational axis R and roll along the floor surface F are contemplated. The stem 80 is supported in the base 34 such that the stem 80 is able to swivel relative to the base 34 about a swivel axis S when the caster assembly 70a is changing orientation, but the stem 80 is fixed from axial movement relative to the base 34 along the swivel axis S. Retaining rings, clips, bearing arrangements, or other structures may be present to secure the stem 80 to the base 34, as is conventional in the art. The fork member 72 is coupled to the stem 80 via the post 76, such that as the stem 80 swivels about the swivel axis S, so does the fork member 72 and the wheel 68. The stem 80 may also be referred to as a kingpin, spindle, swivel post, or the like. Additionally, another stem, kingpin, spindle, or the like may be located between the stem 80 and the base 34, along with suitable bearings/bushings, to allow the stem 80 to swivel relative to the base 34. Thus, various swivel assemblies comprising a swivel joint at which the wheel 68 is able to swivel relative to the base 34 are possible.

The caster assembly 70a further comprises a tilt assembly to facilitate tilting of the wheel 68 about a tilting axis T when the wheel 68 encounters a stall zone Z during its transition from one orientation to another, such as when the caregiver changes the direction of movement of the patient transport apparatus 30. An example of the stall zone Z is shown in FIG. 2A. In this illustration, the caster assembly 70a is shown in solid lines in its current orientation, a change in the desired direction of movement of the patient transport apparatus 30 is represented by an arrow, and the trailing orientation of the caster assembly 70a associated with the change in direction is shown by hidden lines. In order for the caster assembly 70a to make the transition from its current orientation to the trailing orientation, the caster assembly 70a must pass through the stall zone Z in which the wheel 68 ceases rolling along the floor surface F, and instead pivots relative to the floor surface F. Various tilt assemblies are shown and described herein to assist with easing pivoting of the wheel 68 through the stall zone Z, but variations of such tilt assemblies are also contemplated. In the version shown in FIGS. 2 and 3, the tilt assembly comprises a tilt pin 78. The tilt pin 78 is supported within the stem 80 for pivoting relative to the stem 80 about the tilting axis T. The tilt pin 78 is supported in the stem 80 such that the tilt pin 78 is able to pivot relative to the base 34 about the tilting axis T, but the tilt pin 78 is fixed from axial movement relative to the stem 80 along the tilting axis T. Retaining rings, clips, bearing arrangements, or other structures may be present to secure the tilt pin 78 to the stem 80. The fork member 72 and post 76 are fixed to the tilt pin 78, such that as the tilt pin 78 pivots about the tilting axis T, so does the fork member 72, the axle 74, and the wheel 68. The tilting axis T may be perpendicular to the swivel axis S and may intersect the swivel axis S (see FIG. 2). The tilting axis T may also be perpendicular to, yet offset from, the rotational axis R.

Referring specifically to FIG. 3, the wheel 68, also referred to herein as a wheel assembly, comprises a wheel center 82 and wheel edges 84. The wheel center 82 has a higher coefficient of friction than the wheel edges 84.

In some embodiments, the wheel center 82 comprises a first material and the wheel edges 84 comprise a second material, wherein the first material is different than the second material. The first material may be softer and have a greater coefficient of friction than the second material. The first material provides the wheel with increased grip on the floor surface F when the wheel 68 is in a first, upright position or orientation, and the second material allows for reduced grip on the floor surface F when the wheel 68 is not in an upright position. To this end, the first material provides the wheel 68 with suitable grip on the floor surface F when the patient transport apparatus 30 is moving, and, advantageously, allows for decreased grip on the floor surface F when the caster assembly 70a is in a stalled state due to a change in direction.

The wheel center 82 comprises, consists essentially of, or consists of, the first material, which may be a polymer. In many embodiments, the first material is selected from elastomers, thermoplastic elastomers, thermoplastics, and combinations thereof. Other first materials are also contemplated.

Various non-limiting examples of suitable elastomers include natural rubber (natural polyisoprene), synthetic polyisoprene, polybutadiene, chloroprene rubber, butyl rubber, halogenated butyl rubber, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomer, perfluoroelastomer, polyether block amides, chlorosulfonated polyethylene, and ethylene-vinyl acetate. For example, in one specific non-limiting embodiment, the first material comprises polyamide.

Various non-limiting examples of suitable thermoplastics and thermoplastic elastomers include polyolefins, polyolefin elastomers, polyvinylchlorides (PVC), polyamides (PA), styrenic elastomers, thermoplastic vulcanate elastomer (TPV), fluoropolymers, silicones, polyesters, polyoxymethylenes (POM), polyurethane, thermoplastic polyurethanes (TPU), and combinations thereof. For example, in one specific embodiment, the first material comprises thermoplastic polyurethane, polyoxymethylene, polyalkylene terephthalate, and combinations thereof. By way of a non-limiting example, the first material comprises polyurethane or a thermoplastic polyurethane (TPU).

In some embodiments, the first material has a Shore A hardness of from about 70 to about 110, or from about 85 to about 95, when tested in accordance with ASTM D2240, Standard Test Method for Rubber Property—Durometer Hardness. In one embodiment, the first material has a Shore A hardness of 90. In various non-limiting embodiments, all values and ranges of values between the aforementioned values are hereby expressly contemplated.

The wheel edges 84 comprise, consists essentially of, or consist of, the second material, which may be a polymer, metal, or combinations thereof. Other second materials are also contemplated. Like the first material, the second material may be selected from elastomers, thermoplastic elastomers, thermoplastics, and combinations thereof. Such materials are described above. That is, the second material can comprise, consist essentially of, or consist of any combination of materials used to describe the first material above with the caveat that the second material is different than the first material. That is, although the second material comprises, consists essentially of, or consists of, a polymer, the second material is, in many embodiments, different than the first material. In particular, the second material is typically harder and has a lower coefficient of friction than the first material. In one specific embodiment, the second material may be nylon, such as nylon 66.

In some embodiments, the second material has a Shore D hardness of from about 60 to about 100, or from about 70 to about 90, or from about 75 to about 95, when tested in accordance with ASTM D2240, Standard Test Method for Rubber Property—Durometer Hardness. In one embodiment, the second material has a Shore D hardness of 80. In various non-limiting embodiments, all values and ranges of values between the aforementioned values are hereby expressly contemplated.

In embodiments where the second material is harder than the first material, the second material can have a Shore A hardness which is a hardness greater than about 2, about 4, about 6, about 8, about 10, about 12, about 14, about 16, about 18, about 20, about 22, about 24, about 26, about 28, or about 30, durometer units than the hardness of the first material, when tested in accordance with ASTM D2240, Standard Test Method for Rubber Property—Durometer Hardness. Similarly, the second material may be better measured using a Shore D scale by virtue of being substantially harder than the first material.

As is described above, the wheel 62 includes the center 82 and the first and second edges 84. The center 82, which defines a surface, has a greater coefficient of friction than the first and second edges 84, which also define surfaces. The center 82 can have a higher static and/or dynamic coefficient of friction. The coefficient of friction can be tested via various testing methods known in the art. The coefficient of friction of the first and second edges 84 is lower to allow for decreased grip on the floor surface F when the caster assembly 70a is in a stalled state due to a change in direction whereas the coefficient of friction of the center 82 is higher to provide stability when the patient transport apparatus 30 is moving. Coefficient of friction can be tested via various testing methods known in the art.

Embodiments wherein the center 82 comprises the same material as the first and second edges 84 are also contemplated herein. In embodiments where the center 82 and the first and second edges 84 comprise the same material, suitable materials are described above with reference to the first material. In such embodiments, the center 82 (or the surface defined thereby) can be textured to increase its coefficient of friction, and/or the first and second edges 84 can also be textured (e.g., smoother) to decrease their coefficient of friction. Further, embodiments wherein a coating is applied to the first and second edges 84 to decrease their coefficient of friction are also contemplated herein.

The tilt assembly further comprises a biasing device, such as a torsion spring 86. Other forms of biasing devices are also contemplated. The torsion spring 86 is shown within the stem 80. The torsion spring 86 acts between the tilt pin 78 and the stem 80 to provide a biasing force that tries to maintain the wheel 68 in a first position about the tilting axis T in which the wheel 68 is oriented vertically upright relative to the floor surface F, as shown in FIG. 3. This is the normal state of the torsion spring 86. In some cases, the torsion spring 86 is at rest in the normal state. The torsion spring 86 operatively acts between the stem 80 and the wheel support to keep the wheel 68 upright in the first position. In the first position, the wheel 68 rolls along the softer wheel center 82, which provides better grip to the floor surface F due to its higher coefficient of friction.

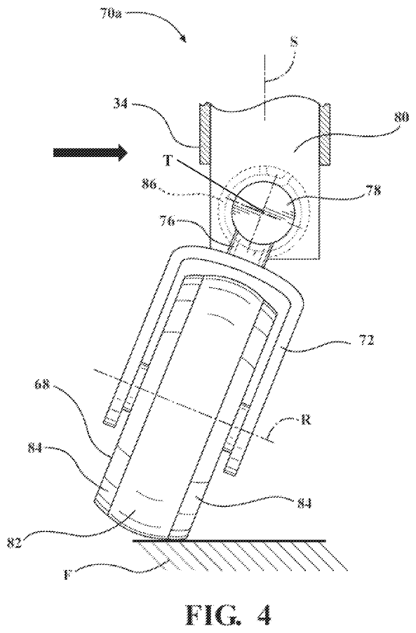

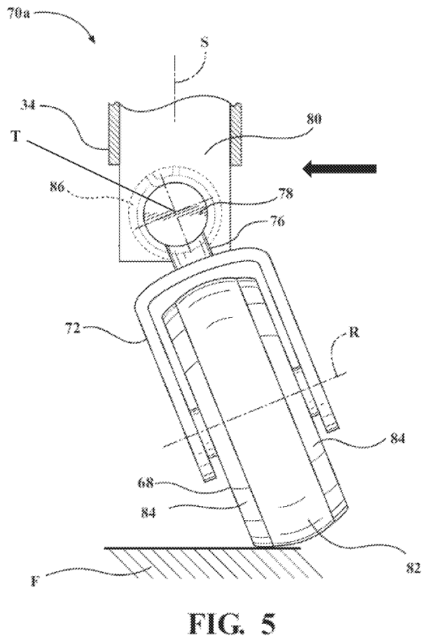

Referring now to FIGS. 4-5, front views of the caster assembly 70a with the wheel 68 in a second position and a third position, respectively, are shown. The wheel 68 has been placed in these positions due to a caregiver changing a direction of movement by applying a pushing force (see arrow in FIGS. 4 and 5) to the patient transport apparatus 30 transverse to the current orientation of the caster assembly 70a. In FIGS. 4 and 5, owing to the force being applied by the caregiver in the direction shown, the torsion spring 86 has been placed in a biased state and acts to apply a biasing force toward the first position to return the wheel 68 to its first position. When the wheel 68 (and the tilt pin 78) is in the second and third positions, the wheel 68 is tilted downwardly at an acute angle, e.g., between 0 and 90 degrees relative to the floor surface F. The rotational axis R is thus also tilted downwardly toward the floor surface F. The second and third positions would also occur, for example, during the transition of the wheel 68 from a leading orientation to a trailing orientation when the direction of the patient transport apparatus 30 is changed, and when the wheel 68 encounters the stall zone Z. However, in both the second and third positions, by virtue of the tilting action provided by the tilt assembly, the primary portion, and in some cases the only portion, of the wheel 68 that is in contact with the floor surface F is one wheel edge 84. Accordingly, owing to the low coefficient of friction between the wheel edge 84 and the floor surface F, the caregiver experiences a smoother and easier transition from the wheels current orientation to the trailing orientation since the start-up pushing forces required by the caregiver are less to pivot the wheel 68 through the stall zone Z as compared to conventional caster wheels.

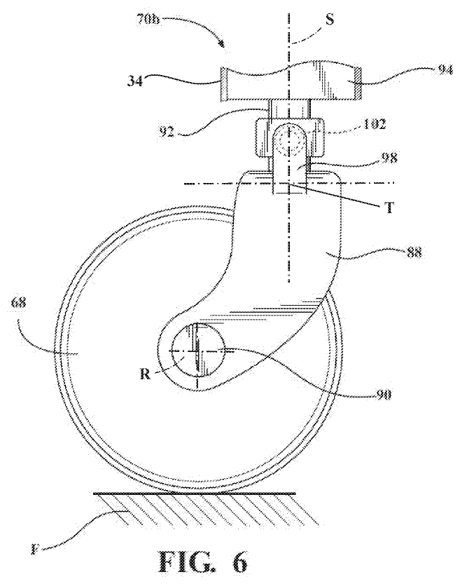

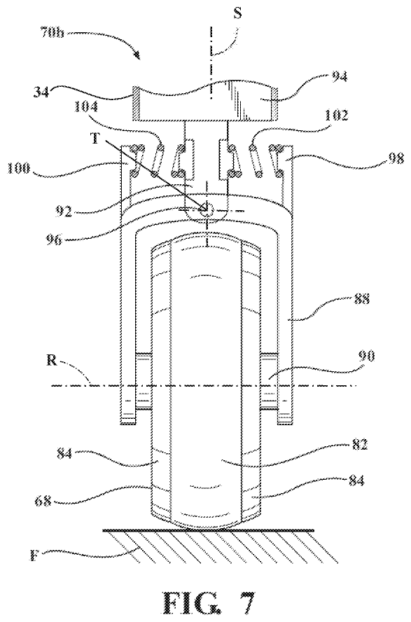

Referring now to FIGS. 6 and 7, a caster assembly 70b according to a second embodiment is shown. The caster assembly 70b comprises the wheel 68, a wheel support, and a stem 94. The wheel support is arranged to support the wheel 68 for rotation when rolling along the floor surface F. The wheel support may comprise various types of support structures. The wheel support shown in FIG. 6 comprises a caster horn having a fork member 88 and a post 92 coupled to the fork member 88. The wheel 68 is secured to the fork member 88 via an axle 90. The wheel 68 is arranged to rotate about a rotational axis R defined through the axle 90. The wheel 68 may rotate relative to the axle 90 via a wheel bearing (not shown) or the wheel 68 may be fixed to the axle 90 to rotate with the axle 90 relative to the fork member 88. Other configurations that allow the wheel 68 to rotate about the rotational axis R and roll along the floor surface F are contemplated. The stem 94 is supported in the base 34 such that the stem 94 is able to swivel relative to the base 34 about a swivel axis S when the caster assembly 70b is changing orientation, but the stem 94 is fixed from axial movement relative to the base 34 along the swivel axis S. Retaining rings, clips, bearing arrangements, or other structures may be present to secure the stem 94 to the base 34, as is conventional in the art. The fork member 88 is coupled to the stem 94 via the post 92, such that as the stem 94 swivels about the swivel axis S, so does the fork member 88 and the wheel 68.

The caster assembly 70b further comprises a tilt assembly to facilitate tilting of the wheel 68 about a tilting axis T when the wheel 68 encounters the stall zone Z during its transition from one orientation to another, such as when the caregiver changes the direction of movement of the patient transport apparatus 30. In the version shown in FIGS. 6 and 7, the tilt assembly comprises a tilt pin 96. The tilt pin 96 is supported within the post 92 for pivoting relative to the post 92 about the tilting axis T. The tilt pin 96 is supported in the post 92 such that the tilt pin 96 is able to pivot relative to the stem 94 and the base 34 about the tilting axis T. Retaining rings, clips, bearing arrangements, or other structures may be present to secure the tilt pin 96 to the post 92. The fork member 88 and post 92 are pivotally coupled together via the tilt pin 96 to allow the fork member 88, the axle 90, and the wheel 68 to tilt about the tilting axis T relative to the post 92. The tilting axis T may be perpendicular to the swivel axis S and may intersect the swivel axis S (see FIG. 7). The tilting axis T may also be perpendicular to, yet offset from, the rotational axis R.

The tilt assembly shown in FIGS. 6 and 7 further comprises two spring arms 98, 100. The spring arms 98, 100 extend above the fork member 88. Two springs 102, 104 are disposed between the spring arms 98, 100 and the stem 92. The springs 102, 104 collectively act to provide a biasing force that tries to maintain the wheel 68 in a first position about the tilting axis T in which the wheel 68 is oriented vertically relative to the floor surface F, as shown in FIG. 7. This is the normal state of the springs 102, 104. In some cases, the springs 102, 104 are at rest in the normal state, but may both be in tension or compression in the normal state, but in equal and opposite directions thereby providing a net zero biasing force in the normal state. In the first position of the wheel 68, the wheel 68 rolls along the softer wheel center 82, which provides better grip to the floor surface F due to its higher coefficient of friction.

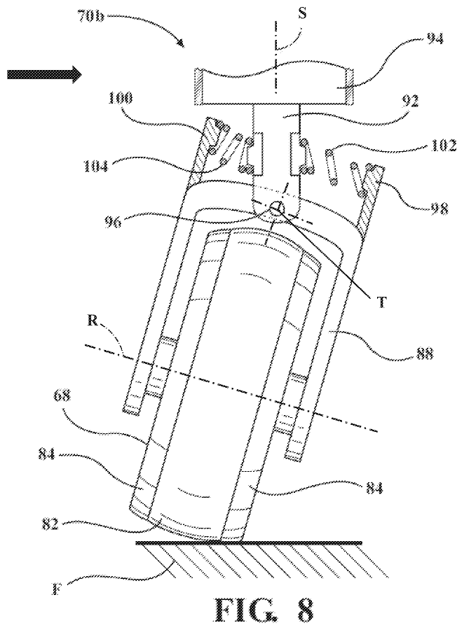

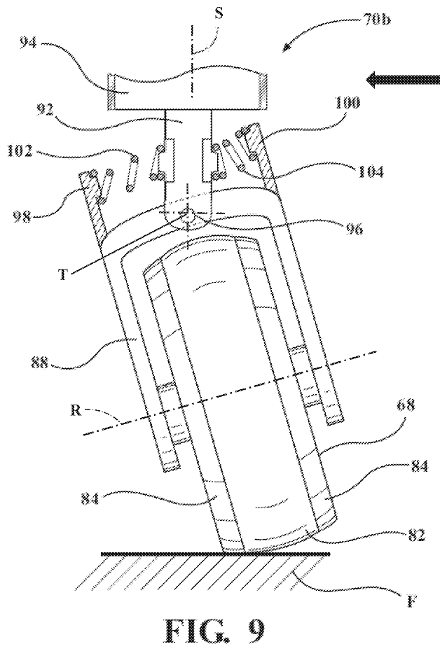

Referring now to FIGS. 8-9, front views of the caster assembly 70b with the wheel 68 in a second and third position, respectively, are shown. The wheel 68 has been placed in these positions due to a caregiver changing a direction of movement by applying a pushing force (see arrow in FIGS. 8 and 9) to the patient transport apparatus 30 transverse to the current orientation of the caster assembly 70b. In FIGS. 8 and 9, owing to the force being applied by the caregiver in the direction shown, the springs 102, 104 have been placed in a biased state and act to apply a biasing force toward the first position to return the wheel 68 to its first position. For example, in FIG. 8, the spring 102 is placed in tension, while the spring 104 is placed in compression. When the wheel 68 is in the second and third positions, the wheel 68 is tilted downwardly at an angle between 0 and 90 degrees relative to the floor surface F. The rotational axis R is thus also tilted downwardly toward the floor surface F. The second and third positions would also occur, for example, during the transition of the wheel 68 from a leading orientation to a trailing orientation when the direction of the patient transport apparatus 30 is changed, and when the wheel 68 encounters the stall zone Z. However, in both the second and third positions, by virtue of the tilting action provided by the tilt assembly, the primary portion, and in some cases the only portion, of the wheel 68 that is in contact with the floor surface F is one wheel edge 84. Accordingly, owing to the low coefficient of friction between the wheel edge 84 and the floor surface F, the caregiver experiences a smoother and easier transition from the wheels current orientation to the trailing orientation since the start-up pushing forces required by the caregiver are less to pivot the wheel 68 through the stall zone Z as compared to conventional caster wheels.

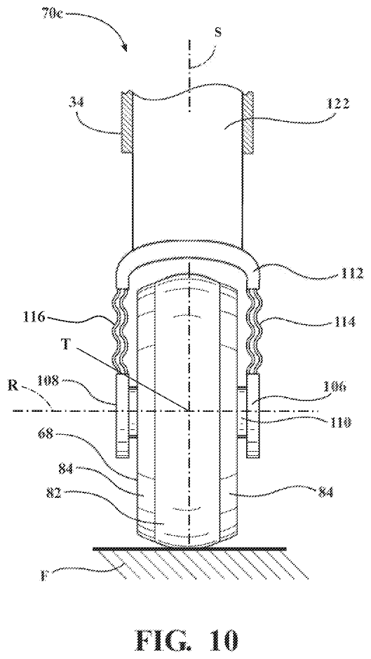

Referring now to FIG. 10, a front view of a caster assembly 70c according to a third embodiment is shown. The caster assembly 70c comprises the wheel 68, a wheel support, and a stem 122. The wheel support is arranged to support the wheel 68 for rotation when rolling along the floor surface F. The wheel support may comprise various types of support structures. The wheel support shown in FIG. 10 comprises a caster horn having a fork member 112. In this version, the fork member 112 is fixed to the stem 122.

The caster assembly 70c further comprises a tilt assembly to facilitate tilting of the wheel 68 about a tilting axis T when the wheel 68 encounters the stall zone Z during its transition from one orientation to another, such as when the caregiver changes the direction of movement of the patient transport apparatus 30. In this version, the tilting axis T is represented as an axis parallel to the floor surface F passing through a center of the wheel 68 about which the wheel 68 tilts when encountering the stall zone Z. In the version shown in FIG. 10, the tilt assembly comprises flexible members 114, 116, which are coupled at a first end to rigid axle support members 106, 108, respectively, and to the fork member 112 at a second end. The wheel 68 is secured to the rigid axle support members 106, 108 via an axle 110. The axle support members 106, 108 can be considered part of the wheel support. The wheel 68 is arranged to rotate about a rotational axis R defined through the axle 110. The wheel 68 may rotate relative to the axle 110 via a wheel bearing (not shown) or the wheel 68 may be fixed to the axle 110 to rotate with the axle 110 relative to the rigid axle support members 106, 108. Other configurations that allow the wheel 68 to rotate about the rotational axis R and roll along the floor surface F are contemplated. The stem 122 is supported in the base 34 but the stem 122 is fixed from axial movement relative to the base 34 along a swivel axis S. Retaining rings, clips, bearing arrangements, or other structures may be present to secure the stem 122 to the base 34, as is conventional in the art.

The flexible members 114, 116 act to provide a biasing force that tries to maintain the wheel 68 in a first position about the tilting axis T in which the wheel 68 is oriented vertically relative to the floor surface F, as shown in FIG. 10. This is the normal state of the flexible members 114, 116. In some cases, the flexible members 114, 116 comprise leaf springs that are at rest in the normal state. In the first position of the wheel 68, the wheel 68 is rolling along the softer wheel center 82, which provides better grip to the floor surface F due to its higher coefficient of friction.

Similar to FIGS. 4-5 and 8-9, force may be applied to wheel 68 in either direction, whereby flexible members 114, 116 flex to allow tilting of the wheel 68 about the tilt axis T, such that only one of the wheel edges 84 are in contact with the floor surface F.

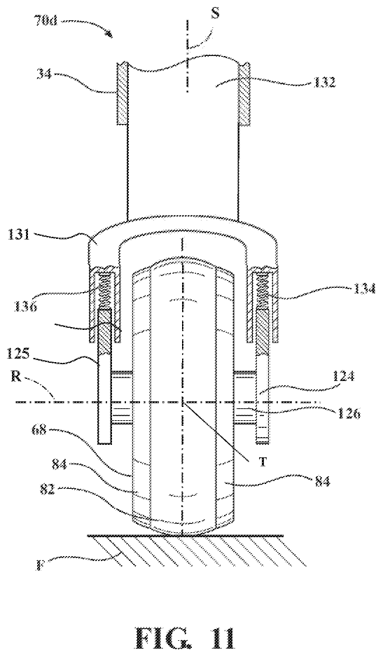

Referring now to FIG. 11, a front view of a caster assembly 70d according to a fourth embodiment is shown. The caster assembly 70d comprises the wheel 68, a wheel support, and a stem 132. The wheel support is arranged to support the wheel 68 for rotation when rolling along the floor surface F. The wheel support may comprise various types of support structures. The wheel support shown in FIG. 11 comprises a caster horn having a fork member 131 fixed to the stem 132.

The caster assembly 70d further comprises a tilt assembly to facilitate tilting of the wheel 68 about the tilting axis T when the wheel 68 encounters the stall zone Z during its transition from one orientation to another, such as when the caregiver changes the direction of movement of the patient transport apparatus 30. In the version shown in FIG. 11, the tilt assembly comprises springs 134, 136 contained within and coupled at a first end to the forks of the fork member 131 within spring cavities within the forks. The springs 134, 136 are fixed at a second end to rigid axle support members 124, 125, respectively. The wheel 68 is secured to the rigid axle support members 124, 125 via an axle 126. The wheel 68 is arranged to rotate about a rotational axis R defined through the axle 126. The wheel 68 may rotate relative to the axle 126 via a wheel bearing (not shown) or the wheel 68 may be fixed to the axle 126 to rotate with the axle 126 relative to the rigid axle support members 124, 126. Other configurations that allow the wheel 68 to rotate about the rotational axis R and roll along the floor surface F are contemplated. The stem 132 is supported in the base 34 but the stem 132 is fixed from axial movement relative to the base 34 along a swivel axis S. Retaining rings, clips, bearing arrangements, or other structures may be present to secure the stem 132 to the base 34, as is conventional in the art.

The springs 134, 136 act to provide a biasing force that tries to maintain the wheel 68 in a first position about the tilting axis T in which the wheel 68 is oriented vertically relative to the floor surface F, as shown in FIG. 11. This is the normal state of the tension springs 134, 136. The springs 134, 136 may both be in compression in the normal state, and may also provide some ride suspension for the patient transport apparatus 30. In the first position of the wheel 68, the wheel 68 is rolling along the softer wheel center 82, which provides better grip to the floor surface F due to its higher coefficient of friction. Similar to FIGS. 4-5 and 8-9, force may be applied to wheel 68 in either direction, whereby one of the tension springs 134, 136 expands and the other compresses to allow tilting of the wheel 68 about the tilt axis T, such that only one of the wheel edges 84 are in contact with the floor surface F.

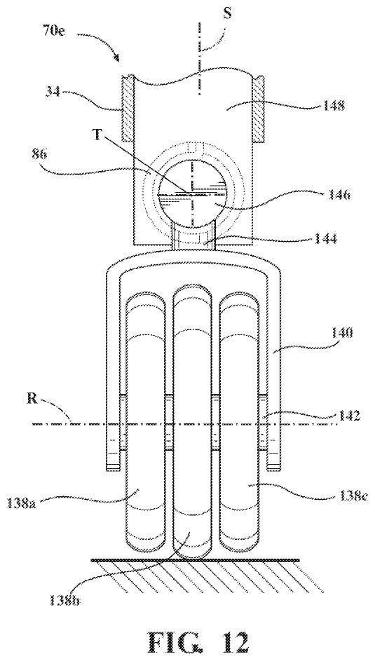

Referring now to FIG. 12, a front view of a caster assembly 70e according to a fifth embodiment is shown. The caster assembly 70e comprises three wheels 138a, 138b, 138c, a wheel support, and a stem 148. The wheels 138a, 138b, 138c may also be referred to as center wheel 138b and outer wheels 138a, 138c. The wheel support is arranged to support the wheels 138a, 138b, 138c for rotation when rolling along the floor surface F. The wheel support may comprise various types of support structures. The wheel support shown in FIG. 12 comprises a caster horn having a fork member 140 and a post 144 fixed to the fork member 140, such that as the stem 148 swivels about the swivel axis S, so does the fork member 140 and the wheels 138a, 138b, 138c.

The caster assembly 70e further comprises a tilt assembly to facilitate tilting of the wheels 138a, 138b, 138c about a tilting axis T when the wheels 138a, 138b, 138c encounter the stall zone Z during its transition from one orientation to another, such as when the caregiver changes the direction of movement of the patient transport apparatus 30. In the version shown in FIG. 12, the tilt assembly comprises a tilt pin 146. The tilt pin 146 is supported within the stem 148 for pivoting relative to the stem 148 about the tilting axis T. The tilt pin 146 is supported in the stem 148 such that the tilt pin 146 is able to pivot relative to the base 34 about the tilting axis T, but the tilt pin 146 is fixed from axial movement relative to the stem 148 along the tilting axis T. Retaining rings, clips, bearing arrangements, or other structures may be present to secure the tilt pin 146 to the stem 148. The fork member 140 and post 144 are fixed to the tilt pin 146, such that as the tilt pin 146 pivots about the tilting axis T, so does the fork member 140 and the wheels 138a, 138b, 138c. The tilting axis T may be perpendicular to the swivel axis S and may intersect the swivel axis S. The tilting axis T may also be perpendicular to, yet offset from, the rotational axis R.

In this embodiment, the separate wheels 138a, 138b, 138c collectively function as a wheel assembly in which the wheel 138b is the center and the wheels 138a, 138c are the edges. The wheel 138b has a higher coefficient of friction than the wheels 138a, 138c. In some embodiments, the wheel 138b comprises a first material and the wheels 138a, 138c comprise a second material wherein the first material is different than the second material. The first material is typically softer and has a greater coefficient of friction than the second material. The first material provides the wheel 138b with increased grip on the floor surface F when the wheels 138a, 138b, 138c are in a first, upright position or orientation, and the second material allows for reduced grip on the floor surface F when the wheels 138a, 138b, 138c are not in an upright position.

The wheel 138b comprises, consists essentially of, or consists of, the first material, which may be a polymer. In many embodiments, the first material is selected from elastomers, thermoplastic elastomers, thermoplastics, and combinations thereof. Other first materials are contemplated.

Various non-limiting examples of suitable elastomers include natural rubber (natural polyisoprene), synthetic polyisoprene, polybutadiene, chloroprene rubber, butyl rubber, halogenated butyl rubber, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomer, perfluoroelastomer, polyether block amides, chlorosulfonated polyethylene, and ethylene-vinyl acetate. For example, in one specific non-limiting embodiment, the first material comprises polyamide.

Various non-limiting examples of suitable thermoplastics and thermoplastic elastomers include polyolefins, polyolefin elastomers, polyvinylchlorides (PVC), polyamides (PA), styrenic elastomers, thermoplastic vulcanate elastomer (TPV), fluoropolymers, silicones, polyesters, polyoxymethylenes (POM), polyurethane, thermoplastic polyurethanes (TPU), and combinations thereof. For example, in one specific embodiment, the first material comprises thermoplastic polyurethane, polyoxymethylene, polyalkylene terephthalate, and combinations thereof. By way of a non-limiting example, the first material comprises polyurethane or a thermoplastic polyurethane (TPU).

In some embodiments, the first material has a Shore A hardness of from about 70 to about 110, or from about 85 to about 95, when tested in accordance with ASTM D2240, Standard Test Method for Rubber Property—Durometer Hardness. In one embodiment, the first material has a Shore A hardness of 90. In various non-limiting embodiments, all values and ranges of values between the aforementioned values are hereby expressly contemplated.

The wheels 138a, 138c comprise, consist essentially of, or consist of, the second material, which may be a polymer, metal, or combinations thereof. Other second materials are contemplated. The second material may be selected from elastomers, thermoplastic elastomers, thermoplastics, and combinations thereof. Such materials are described above. That is, the second material can comprise, consist essentially of, or consist of any combination of materials used to describe the first material above with the caveat that the second material is different than the first material. That is, although the second material comprises, consists essentially of, or consists of, a polymer, the second material is, in many embodiments, different than the first material. In particular, the second material is typically harder and has a lower coefficient of friction than the first material. In one specific embodiment, the second material may be nylon, such as nylon 66.

In some embodiments, the second material has a Shore D hardness of from about 60 to about 100, or from about 70 to about 90, or from about 75 to about 95, when tested in accordance with ASTM D2240, Standard Test Method for Rubber Property—Durometer Hardness. In one embodiment, the second material has a Shore D hardness of 80. In various non-limiting embodiments, all values and ranges of values between the aforementioned values are hereby expressly contemplated.

In embodiments where the second material is typically harder than the first material, the second material can have a Shore A hardness which is a hardness greater than about 2, about 4, about 6, about 8, about 10, about 12, about 14, about 16, about 18, about 20, about 22, about 24, about 26, about 28, or about 30, durometer units than the hardness of the first material, when tested in accordance with ASTM D2240, Standard Test Method for Rubber Property-Durometer Hardness. Similarly, the second material may be better measured using a Shore D scale by virtue of being substantially harder than the first material.

The wheel 138b, which defines a surface, has a greater coefficient of friction than the wheels 138a, 138c, which also define surfaces. The wheel 138b can have a higher static and/or dynamic coefficient of friction. The coefficient of friction can be tested via various testing methods known in the art. The coefficient of friction of the wheels 138a, 138c is lower to allow for decreased grip on the floor surface F when the caster assembly 70e is in a stalled state due to a change in direction whereas the coefficient of friction of the center wheel 138b is higher to provide stability when the patient transport apparatus 30 is moving. Coefficient of friction can be tested via various testing methods known in the art.

Embodiments wherein the wheel 138b comprises the same material as the wheels 138a, 138c are also contemplated herein. In embodiments where the wheel 138b and the wheels 138a, 138c comprise the same material, suitable materials are described above with reference to the first material. In such embodiments, the wheel 138b (or the surface defined thereby) can be textured to increase its coefficient of friction, and/or the wheels 138a, 138c can also be textured (e.g., smoother) to decrease their coefficient of friction. Further, embodiments wherein a coating is applied to the wheels 138a, 138c to decrease their coefficient of friction are also contemplated herein.

Torsion spring 86 is shown within the stem 148 to function in the same manner as described with respect to FIGS. 4 and 5. Similar to FIGS. 4 and 5, the wheels 138a, 138b, 138c may be moved into a second and third position, when force is applied to wheels 138a, 138b, and 138c in either direction, whereby the torsion spring 86 has been placed in a biased state and acts to apply a biasing force to return the wheels 138a, 138b, 138c to their first position. The second and third positions occur, for example, during the transition of the wheels 138a, 138b, and 138c from a leading orientation to a trailing orientation when the direction of the patient transport apparatus 30 is changed, which would normally result in the wheel 138b encountering the stall zone Z. However, in both the second and third positions, by virtue of the tilting action provided by the tilt assembly, only one of the wheels 138a or 138c is in contact with the floor surface F. Accordingly, owing to the low coefficient of friction between the wheels 138a, 138c and the floor surface F, the caregiver experiences a smoother and easier transition from the wheels current orientation to the trailing orientation since the start-up pushing forces required by the caregiver are less to pivot the wheels 138a, 138b, and 138c through the stall zone Z as compared to conventional caster wheels.

Although this three-wheel embodiment is shown in connection with a tilting mechanism similar to the first embodiment, it will be understood that any of the other embodiments disclosed herein may alternatively utilize a three-wheel configuration instead of the illustrated one-wheel configuration. Other wheel configurations with multiple wheels are also contemplated.

It will be further appreciated that the terms “include,” “includes,” and “including” have the same meaning as the terms “comprise,” “comprises,” and “comprising.”

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A patient transport apparatus comprising:
a support structure comprising a base and a patient support surface for supporting a patient;
a caster assembly coupled to the base, the caster assembly comprising a wheel assembly including a first edge, a second edge, and a center disposed between the first edge and the second edge, each of the edges having a lower coefficient of friction than the center; and
a tilt assembly coupled to the wheel assembly and configured to allow the wheel assembly to tilt relative to a floor surface such that at least one of the first and second edges contact the floor surface.

2. The patient transport apparatus of claim 1, wherein the first and second edges of the wheel assembly are formed of a first material and the center of the wheel assembly is formed of a second material which is different than the first material.

3. The patient transport apparatus of claim 2, wherein the hardness of the center is less than the hardness of the first and second edges, when tested in accordance with ASTM D2240.

4. The patient transport apparatus of claim 2, wherein the first material comprises a thermoplastic.

5. The patient transport apparatus of claim 2, wherein the second material comprises elastomer or rubber.

6. The patient transport apparatus of claim 1, wherein the caster assembly comprises a stem supported by the base and a wheel support rotatably supporting the wheel assembly.

7. The patient transport apparatus of claim 6, wherein the tilt assembly comprises a biasing device operatively acting between the stem and the wheel support to bias the wheel assembly toward a first position.

8. The patient transport apparatus of claim 7, wherein the tilt assembly is configured such that the wheel assembly is oriented vertically relative to the floor surface and the center of the wheel assembly is in contact with the floor surface in the first position.

9. The patient transport apparatus of claim 8, wherein the tilt assembly is configured to allow the wheel assembly to move to a second position, where the wheel assembly is tilted at an acute angle relative to the floor surface such that one of the first edge or the second edge of the wheel assembly is in contact with the floor surface.

10. The patient transport apparatus of claim 1, wherein the center has a first texture to increase coefficient of friction, and the first and second edges have a second texture to decrease coefficient of friction.

11. A caster assembly comprising:
a wheel assembly including a first edge, a second edge, and a center disposed between the first edge and the second edge, each of the edges having a lower coefficient of friction than the center; and
a tilt assembly coupled to the wheel assembly and configured to allow the wheel assembly to tilt relative to a floor surface such that at least one of the first and second edges contact the floor surface.

12. The caster assembly of claim 11, wherein the first and second edges of the wheel assembly are formed of a first material and the center of the wheel assembly is formed of a second material which is different than the first material.

13. The caster assembly of claim 12, wherein the hardness of the center is less than the hardness of the first and second edges, when tested in accordance with ASTM D2240.

14. The caster assembly of claim 12, wherein the first material comprises thermoplastic.

15. The caster assembly of claim 12, wherein the second material comprises elastomer or rubber.

16. The caster assembly of claim 11, wherein the caster assembly comprises a stem and a wheel support rotatably supporting the wheel assembly.

17. The caster assembly of claim 16, wherein the tilt assembly comprises a biasing device operatively acting between the stem and the wheel support to bias the wheel assembly toward a first position.

18. The caster assembly of claim 17, wherein the tilt assembly is configured such that the wheel assembly is oriented vertically relative to the floor surface and the center of the wheel assembly is in contact with the floor surface in the first position.

19. The caster assembly of claim 18, wherein the tilt assembly is configured to allow the wheel assembly to move to a second position, where the wheel assembly is tilted at an acute angle relative to the floor surface such that one of the first edge or the second edge of the wheel assembly is in contact with the floor surface.

20. The caster assembly of claim 11, wherein the center has a first texture to increase coefficient of friction, and the first and second edges have a second texture to decrease coefficient of friction.
